(19) United States
(12) Patent Application Publication
(10) Pub. No.: US 2009/0136860 A1
(43) Pub. Date: May 28, 2009

(54) ELECTROPHOTOGRAPHIC PHOTORECEPTOR CONTAINING BISAZO-BASED COMPOUND AS A CHARGE GENERATING MATERIAL IN A CHARGE TRANSPORTING LAYER AND ELECTROPHOTOGRAPHIC IMAGING APPARATUS EMPLOYING THE SAME

(75) Inventors: Beom-jun Kim, Yongin-si (KR); Hwan-Koo Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/181,574

(22) Filed: Jul. 29, 2008

(30) Foreign Application Priority Data
Nov. 26, 2007 (KR) 2007-120973

(51) Int. Cl. G03G 15/02

(52) U.S. Cl. 430/58.55; 399/159

(57) ABSTRACT

A laminate type electrophotographic photoreceptor includes an electrically conductive substrate, and a photosensitive layer formed on the electrically conductive substrate, the photosensitive layer includes a charge generating layer and a charge transporting layer, wherein the charge transporting layer contains a bisazo-based compound represented by the following Formula 1 as a charge generating material:

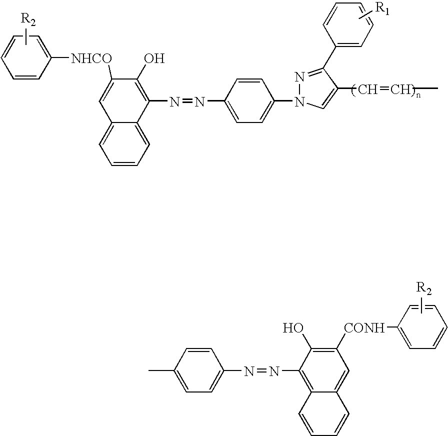

wherein R1 and R2 each independently represent a hydrogen atom, a halogen atom, a C1-C20 substituted or unsubstituted alkyl group, or a C1-C20 substituted or unsubstituted alkoxy group, and n is an integer from 0 to 6. The laminate type electrophotographic photoreceptor according to the present general inventive concept has a high sensitivity and a superior ability to suppress a ghost phenomenon even if repetitively used.

### CROSS-REFERENCE TO RELATED APPLICATIONS

This application claims priority under 35 U.S.C. §119(a) from Korean Patent Application No. 10-2007-0120973, filed on Nov. 26, 2007, in the Korean Intellectual Property Office, the disclosure of which is incorporated herein in its entirety by reference.

### BACKGROUND OF THE INVENTION

1. Field of the Invention

The present general inventive concept relates to an electrophotographic photoreceptor and an electrophotographic imaging apparatus employing the same, and more particularly, to an electrophotographic photoreceptor containing a bisazo-based compound as a charge generating material in a charge transporting layer and having a high sensitivity that can suppress a ghost phenomenon in a repetitive use thereof, and an electrophotographic imaging apparatus employing the same.

2. Description of the Related Art

Electrophotographic devices such as facsimile machines, laser printers, copying machines, CRT printers, liquid crystal printers, LED printers and the like include an electrophotographic photoreceptor including a photosensitive layer formed on an electrically conductive substrate. The electrophotographic photoreceptor can be in a form of a plate, a disk, a sheet, a belt, a drum, or the like and forms an image as follows. First, a surface of the photosensitive layer is uniformly and electrostatically charged, and then a charged surface is exposed to a pattern of light, thus forming the image. The light exposure selectively dissipates the charge in exposed regions where the light strikes the surface, thereby forming a pattern of charged and uncharged regions, which is referred to as a latent.image. Then, a wet or dry toner is provided in a vicinity of the latent image, and toner droplets or particles collect in either the charged or uncharged regions to form a toner image on the surface of the photosensitive layer. A resulting toner image may be transferred to a suitable final or intermediate receiving surface, such as paper, or the photosensitive layer may function as a final receptor for receiving the image. Lastly, a residual electrostatic image on the surface of the photosensitive layer is removed by radiating light, emitted from an eraser lamp, on the surface of the photosensitive layer uniformly. Then, a small amount of residual toner left on the surface of the photosensitive layer is removed by using mechanical components such as a brush or blade.

Electrophotographic photoreceptors are generally categorized into two types. The first is a laminated-type electrophotographic photoreceptor having a laminated structure including a charge generating layer (CGL) including a binder resin and a charge generating material (CGM), and a charge transporting layer (CTL) including a binder resin and a charge transporting material (usually, a hole transporting material (HTM)). In general, laminated-type electrophotographic photoreceptors constitute negative (−) type electrophotographic photoreceptors. The other type is a single layered-type electrophotographic photoreceptor in which a binder resin, a CGM, an HTM, and an electron transporting material (ETM) are included in a single layer. In general, single layered-type electrophotographic photoreceptors constitute positive (+) type electrophotographic photoreceptors.

In recent years, an output speed of electrophotographic imaging apparatuses is increasing, and a demand for an increase in the output speed is anticipated to continue. Accordingly, a high sensitivity of the electrophotographic photoreceptor is required. Since a diameter of an electrophotographic photoreceptor drum is decreasing to meet miniaturization requirements of the electrophotographic imaging apparatuses, increasing the sensitivity of a photoreceptor in order to obtain same output speed is required.

When a laminate type electrophotographic photoreceptor is repeatedly used, holes generated in a CGL during exposure tend not to move through a CTL to a surface of the CTL but tend to stay in the CTL to form charge (e.g., hole) traps. If such charge traps form in the CTL, the sensitivity of the photoreceptor decreases and an electrostatic image remains on the surface of the photoreceptor to cause a ghost image during a printing of a next cycle.

Japanese Patent Laid Open Publication No. 10-177262 relates to a laminate type electrophotographic photoreceptor to suppress variation in electrical potential of an exposed part of an electrophotographic photoreceptor between 1st and 2nd image forming cycles and to prevent an occurrence of black spots, white spots and a ghost phenomenon, the photoreceptor including a charge transporting layer containing a CTM selected from specified triphenylamine compounds and specified N,N,N′,N′-tetraphenylbenzidine compounds.

Japanese Patent Laid Open Publication No. 2001-022109 relates to an electrophotographic photoreceptor having practically sufficient sensitivity and excellent stability in terms of electrostatic characteristics even in a repetitive use thereof, and including an undercoat layer and a photosensitive layer formed on an electrically conductive substrate, the photosensitive layer containing X type metal-free phthalocyanine and a bisazo-based compound having a specified structure, and the undercoat layer containing dendritic or acicular titanium dioxide.

However, there is still a need for an electrostatic photoreceptor with a high sensitivity to suppress a ghost phenomenon that tends to occur in a repetitive use thereof.

### SUMMARY OF THE INVENTION

The present general inventive concept provides an electrophotographic photoreceptor with a high sensitivity that can effectively suppress an occurrence of a ghost phenomenon in a repetitive use thereof.

The present general inventive concept also provides an electrophotographic imaging apparatus employing the above electrophotographic photoreceptor.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a laminate-type electrophotographic photoreceptor including an electrically conductive substrate, and a photosensitive layer formed on the electrically conductive substrate, wherein the photosensitive layer includes a charge generating layer and a charge transporting layer, wherein the charge transporting layer contains a bisazo-based compound represented by the following Formula 1 as a charge generating material:

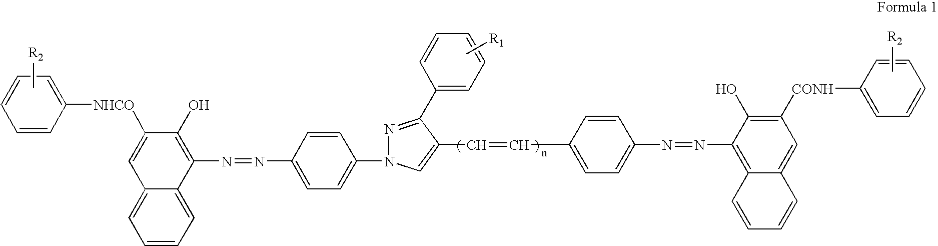

wherein R1 and R2 each independently represent a hydrogen atom, a halogen atom, a C1-C20 substituted or unsubstituted alkyl group, or a C1-C20 substituted or unsubstituted alkoxy group, and n is an integer in a range from 0 to 6.

The foregoing and/or other aspects and utilities of the general inventive concept may also be achieved by providing an electrophotographic imaging apparatus including an electrophotographic photoreceptor, the electrophotographic photoreceptor being a laminate-type electrophotographic photoreceptor including an electrically conductive substrate, and a photosensitive layer formed on the electrically conductive substrate, wherein the photosensitive layer includes a charge generating layer and a charge transporting layer, wherein the charge transporting layer contains a bisazo-based compound represented by the foregoing Formula 1 as a charge generating material.

R1 may be a C1-C7 alkyl group or a C1-C7 alkoxy group, and R2 may be a chlorine atom, a C1-C7 alkyl group or a C1-C7 alkoxy group.

The CGL may contain a phthalocyanine-based pigment as the CGM, and the CTL may further contain an arylamine-based compound as an HTM (hole transporting material).

The foregoing and/or other aspects and utilities of the general inventive concept may also be achieved by providing a laminate type electrophotographic photoreceptor usable with an electrophotographic imaging apparatus, the laminate type electrophotographic photoreceptor including a charge generating layer, and a charge transporting layer, the charge transporting layer having a bisazo-based compound represented by the following formula as a charge generating material:

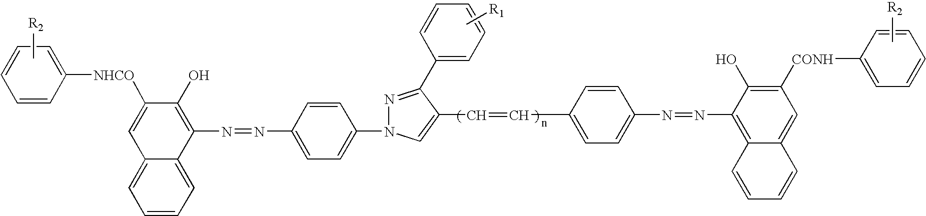

wherein R1 and R2 each independently represent a hydrogen atom, a halogen atom, a C1-C20 substituted or unsubstituted alkyl group, or a C1-C20 substituted or unsubstituted alkoxy group, and n is an integer in a range from 0 to 6.

### BRIEF DESCRIPTION OF THE DRAWINGS

The above and other aspects and utilities of the present general inventive concept will become more apparent by describing in detail exemplary embodiments thereof with reference to the attached drawings in which:

FIG. 1 is a schematic view illustrating an electrophotographic imaging apparatus according to an embodiment of the present general inventive concept;

FIG. 2 are photographs illustrating results of a ghost evaluation of electrophotographic photoreceptors of embodiments of the present general inventive concept and comparative examples; and

FIG. 3 illustrates an absorption spectra of compound 2 and compound 3 which are charge generating materials added in a charge transporting layer (CTL) of an electrophotographic photoreceptor according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

An electrophotographic photoreceptor according to an embodiment of the present general inventive concept is a laminated type electrophotographic photoreceptor in which a charge generating layer and a charge transporting layer are sequentially formed on an electrically conductive substrate, wherein the charge generating layer and the charge transporting layer together constitute a photosensitive layer. However, the present invention is not limited thereto, and a formation sequence of the charge transporting layer and the charge generating layer can be reversed.

The electrically conductive substrate may be in a form of a drum, pipe, belt, plate or the like which may include any conductive material, for example, a metal, or an electrically conductive polymer, or the like. The metal may be aluminium, vanadium, nickel, copper, zinc, palladium, indium, tin, platinum, stainless steel, chrome, or the like. The electrically conductive polymer may be a polyester resin, polycarbonate resin, a polyamide resin, a polyimide resin, mixtures thereof, or a copolymer of monomers used in preparing the resins described above in which an electrically conductive material such as a conductive carbon, tin oxide, indium oxide, or the like is dispersed. An organic polymer sheet on which a metal is deposited or a metal sheet is laminated may be used as the electrically conductive substrate.

An undercoat layer may be further formed between the electrically conductive substrate and the photosensitive layer in order to prevent charge injection to the photosensitive layer from the electrically conductive substrate and/or improve adhesion therebetween.

The undercoat layer may be formed by dispersing a conductive powder such as carbon black, graphite, metal powder, or a metal oxide powder such as indium oxide, tin oxide, indium tin oxide, or titanium oxide in a binder resin such as polyamide, polyvinylalcohol, casein, ethylcellulose, gelatin, a phenol resin, or the like. The undercoat layer in this form may have a thickness of about 5 μm to about 50 μm. The undercoat layer may be also formed of an inorganic layer, for example, anodic aluminium oxide, aluminium oxide, and aluminium hydroxide. The inorganic layer, such as the anodic aluminium oxide, has a thickness in a range of approximately 0.05 μm to approximately 5 μm. The respective two types of undercoat layers may be formed together.

The photosensitive layer including the charge generating layer and the charge transporting layer is formed on the electrically conductive substrate of the laminated-type electrophotographic photoreceptor according to the present general inventive concept.

A charge generating material used to form the charge generating layer may be an organic pigment or an inorganic pigment. If an organic pigment is used as the charge generating material, electrical properties of the electrophotographic photoreceptor can easily be adjusted and various crystalline structures can be obtained depending on synthesis methods and processing conditions. Thus, in an embodiment of the present general inventive concept, a use of an organic pigment is to form the charge generating layer. Examples of the charge generating material may include a phthalocyanine-based pigment, an azo-based compound, a bisazo-based compound, a triazo-based compound, a quinone-based pigment, a perylene-based compound, an indigo-based compound, a bisbenzoimidazole-based pigment, an anthraquinone-based compound, a quinacridone-based compound, an azulenium-based compound, a squarylium-based compound, a pyrylium-based compound, a triarylmethane-based compound, a cyanine-based compound, a perynone-based compound, a polycycloquinone-based compound, a pyrrolopyrrole-based compound, a naphthalocyanine-based compound, and the like, but the present invention is not limited thereto. The charge generating materials can be used alone or in combination of two or more. The charge generating material may be, for example, a phthalocyanine-based pigment. Examples of the phthalocyanine-based pigment may include a titanyloxy phthalocyanine pigment such as D-type or Y-type titanyloxy phthalocyanine having the strongest diffraction peak at a Bragg angle of about 27.1° (2θ±0.2° ), a β-type titanyloxy phthalocyanine having the strongest diffraction peak at a Bragg angle of about 26.1° (2θ±0.2° ), an α-type titanyloxy phthalocyanine having the strongest diffraction peak at a Bragg angle of about 7.5° (2θ±0.2° ), or the like, in a powder X-ray diffraction peak; or a metal-free phthalocyanine pigment such as X-type metal-free phthalocyanine or τ-type metal-free phthalocyanine having the strongest diffraction peak at Bragg angles of about 7.5° and about 9.2° (2θ±0.2° ) in a powder X-ray diffraction peak. These phthalocyanine-based pigments can be effectively used in the present embodiment because the phthalocyanine-based pigments have the best sensitivity to light with a wavelength of 780 nm-800 nm and the sensitivities can be selected depending on crystal structures.

The charge generating material in the charge generating layer is dispersed in a binder resin. Examples of the usable binder resins are polyvinylbutyral, polyvinyl acetal, polyester, polyamide, polyvinyl alcohol, polyvinyl acetate, polyvinyl chloride, polyurethane, polycarbonate, polymethacryl amide, polyvinylidenchloride, polystyrene, styrene-butadiene copolymer, styrene-methyl methacrylate copolymer, vinylidene chloride-acrylonitril copolymer, vinyl chloride-vinyl acetate copolymer, vinylchloride-vinylacetate-maleic anhydride copolymer, ethylene-acrylic acid copolymer, ethylene-vinyl acetate copolymer, methyl cellulose, ethyl cellulose, nitrocellulose, carboxymethyl cellulose, polysilicone, silicon-alkyd resin, phenol-formaldehyde resin, cresol-formaldehyde resin, phenoxy resin, styrene-alkyd resin, poly-N-vinycarbazole resin, polyvinylformal, polyhydroxystyrene, polynobonyl, polycycloolefin, polyvinylpyrrolidone, poly(2-ethyl-oxazoline), polysulfone, melamine resin, urea resin, amino resin, isocyanate resin, epoxy resin and the like. These binder resins may be used alone or in a combination of two or more of them.

An amount of the binder resin, for example, is in a range of 5-350 parts by weight, such as, in a range of 10-200 parts by weight based on 100 parts by weight of the charge generating material. If the amount of the binder resin is less than 5 parts by weight, the charge generating material is insufficiently dispersed to decrease stability of the dispersion solution, obtaining a uniform charge generating layer when the binder resin is coated on an electrically conductive substrate is difficult, and the adhesive force of the electrically conductive substrate may be reduced. If the amount of the binder resin exceeds 350 parts by weight, maintaining a charged potential, and a desirable image cannot be obtained due to an insufficient sensitivity caused by the excess binder resin is difficult.

A type of solvent used in manufacturing coating slurry to form the charge generating layer may be changed according to a type of binder resin used. Accordingly, a solvent, which does not affect an adjacent layer when the charge generating layer is coated on the electrically conductive substrate, for example, is selected. Particular examples of the solvents include methyl isopropyl ketone, methyl isobutyl ketone, 4-methoxy-4-methyl-2-pentanone, isopropyl acetate, t-butyl acetate, isopropyl alcohol, isobutyl alcohol, acetone, methylethyl ketone, cyclohexanone, 1,2-dichloroethane, 1,1,2-trichloroethane, 1,1,1-trichloroethane, trichloroethylene, tetrachloroethane, dichloromethane, tetrahydrofuran, dioxane, dioxolane, methanol, ethanol, 1-propanol, 1-butanol, 2-butanol, 1-methoxy-2-propanol, ethyl acetate, butyl acetate, dimethyl sulfoxide, methylcellosolve, butyl amine, diethyl amine, ethylene diamine, isopropanol amine, triethanol amine, triethylene diamine, N,N′-dimethyl formamide, 1,2-dimethoxyethane, benzene, toluene, xylene, methylbenzene, ethylbenzene, cyclohexane, anisole, and the like. These solvents may be used alone or in a combination of two or more.

Next, a process of manufacturing coating slurry to form a charge generating layer will be described. First, 100 parts by weight of a charge generating material such as a phthalocyanine pigment and 5 to 350 parts by weight, such as 10 to 200 parts by weight of a binder resin are mixed with an appropriate amount of a solvent, for example, 100 to 10,000 parts by weight, such as 500 to 8,000 parts by weight. Glass beads, steel beads, zirconia beads, alumina beads, zirconia balls, alumina balls, or steel balls are added to the mixture and the resulting mixture are dispersed using a dispersing apparatus for about 2 to 50 hours. The dispersing apparatus used herein may be, for example, an attritor, a ball-mill, a sand-mill, a banburry mixer, a roll-mill, three-roll mill, nanomiser, microfluidizer, a stamp mill, a planetary mill, a vibration mill, a kneader, a homonizer, a Dyno-Mill, a micronizer, a paint shaker, a high-speed agitator, an ultimiser, an ultrasonic homogenizer, or the like. The above dispersing apparatuses may be used alone or in combination of two or more.

The coating slurry to form the charge generating layer is coated on the above-described electrically conductive substrate using a coating method such as a dip coating method, a ring coating method, a roll coating method, a spray coating method, or the like. The coated electrically conductive substrate is dried at 90 to 200° C. for 0.1 to 2 hours, thereby forming the charge generating layer.

A thickness of the charge generating layer may be 0.001 to 10 μm, such as 0.01 to 10 μm, including 0.05 to 3 μm. When the thickness of the charge generating layer is less than 0.001 μm, forming the charge generating layer to have a uniform thickness is difficult. When the thickness of the charge generating layer exceeds 10 μm, electrophotographic characteristics tend to deteriorate.

Next, a charge transporting layer containing a hole transporting material, a bisazo-based charge generating material represented by the Formula 1 above, and a binder resin is laminated on the charge generating layer.

Examples of the hole transporting materials that may be used in the present embodiment include nitrogen containing cyclic compounds or condensed polycyclic compounds such as a hydrazone-based compound, a butadiene-based amine compound, a benzidine-based compound including N,N′-bis-(3-methylphenyl)-N,N′-bis(phenyl)benzidine, N,N,N′,N′-tetrakis(3-methylphenyl)benzidine, N,N,N′,N′-tetrakis(4-methylphenyl)benzidine, N,N′-di(naphthalene-1-yl)-N,N′-di(4-methylphenyl)benzidine, and N,N′-di(naphthalene-2-yl)-N,N′-di(3-methylphenyl)benzidine, a pyrene-based compound, a carbazole-based compound, an arylmethane-based compound, a thiazol-based compound, a styryl-based compound, a pyrazoline-based compound, an arylamine-based compound, an oxazole-based compound, an oxadiazole-based compound, a pyrazolone-based compound, a stilbene-based compound, a polyaryl alkane-based compound, a polyvinylcarbazole-based compound, a N-acrylamide methylcarbazole copolymer, a triphenylmethane copolymer, a styrene copolymer, polyacenaphthene, polyindene, a copolymer of acenaphthylene and styrene, and a formaldehyde-based condensed resin. Also, a high molecular weight compound having substituents of the above compounds in a main chain or a side chain may be used. When used in combination with the bisazo-based charge generating material represented by the above Formula 1, the hole transporting material is, for example, an arylamine-based compound in terms of solubility to a common solvent.

The charge transporting layer of the present general inventive concept includes a bisazo-based charge generating material represented by the following Formula 1 besides the hole transporting material:

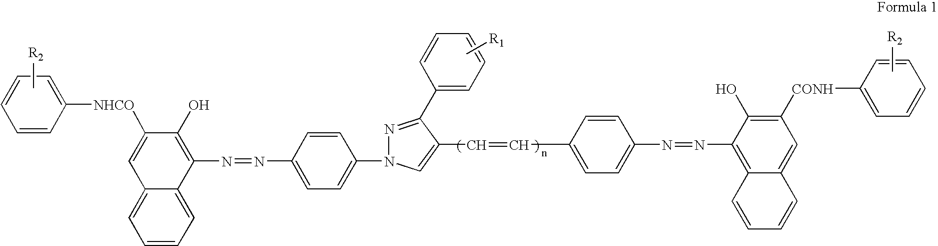

wherein R1 and R2 each independently represent a hydrogen atom, a halogen atom, a C1-C20 substituted or unsubstituted alkyl group, or a C1-C20 substituted or unsubstituted alkoxy group; and wherein n is an integer in a range from 0 to 6.

In an electrophotographic imaging process, the bisazo-based compound represented by the Formula 1 may absorb erasure light having wavelengths in a range of 550 nm to 650 nm and emitted from an eraser lamp of an electrophotographic image apparatus to generate charges. The generated charges can effectively remove charge traps generated in the charge transporting layer, i.e., an electrostatic latent image, thereby exhibiting a superior ability to suppress the ghost phenomenon. Also, since the bisazo-based compound represented by the Formula 1 has a superior solubility to an organic solvent used to manufacture a composition for the charge transporting layer and thus has uniform distribution in the charge transporting layer, the bisazo-based compound can exhibit a particularly superior ability of suppressing the ghost phenomenon. Meanwhile, the bisazo-based charge generating material does not absorb exposure light having a wavelength of 780 nm emitted from a laser scanning unit used as an exposure unit for an electrophotographic imaging apparatus. Accordingly, this bisazo-based compound can absorb the erasure light emitted from the eraser lamp and remove charge traps without badly affecting sensitivity of the electrophotographic photoreceptor, thereby suppressing the ghost phenomenon.

Accordingly, the electrophotographic photoreceptor including a bisazo-based compound in the charge transporting layer according to the present embodiment has a superior sensitivity and may effectively suppress the ghost phenomenon even in a repetitive use thereof. Accordingly, the electrophotographic photoreceptor according to the present embodiment can stably provide a high quality image even in a repetitive use thereof.

In the above Formula 1, the halogen atom represents a fluorine atom, a chlorine atom, a bromine atom, an iodine atom or the like.

In the above Formula 1, the alkyl group is a C1-C20 linear or branched alkyl group, such as, a C1-C7 linear or branched alkyl group, including, a C1-C4 linear or branched alkyl group. Examples of the alkyl groups include methyl, ethyl, n-propyl, isopropyl, n-butyl, isobutyl, sec-butyl, tert-butyl, pentyl, hexyl, 1,2-dimethyl-propyl, 2-ethylhexyl and the like. The alkyl group may be substituted with a halogen atom, such as fluorine, chlorine, bromine or iodine atom.

In the above Formula 1, the alkoxy group is a C1-C20 linear or branched alkoxy group, such as, a C1-C7 linear or branched alkoxy group, including, a C1-C4 linear or branched alkoxy group. Examples of the alkoxy groups include a methoxy group, an ethoxy group, a propoxy group and the like. The alkoxy group may be substituted with a halogen atom, such as fluorine, chlorine, bromine or iodine atom.

In terms of availability and easy absorption of incident light emitted from the eraser lamp, n is an integer in a range from 0 to 6, such as an integer from 0 to 2, including 0 or 1.

The bisazo-based charge generating material represented by the Formula 1 can be formed by a coupling reaction of a typical bisazonium compound as follows:

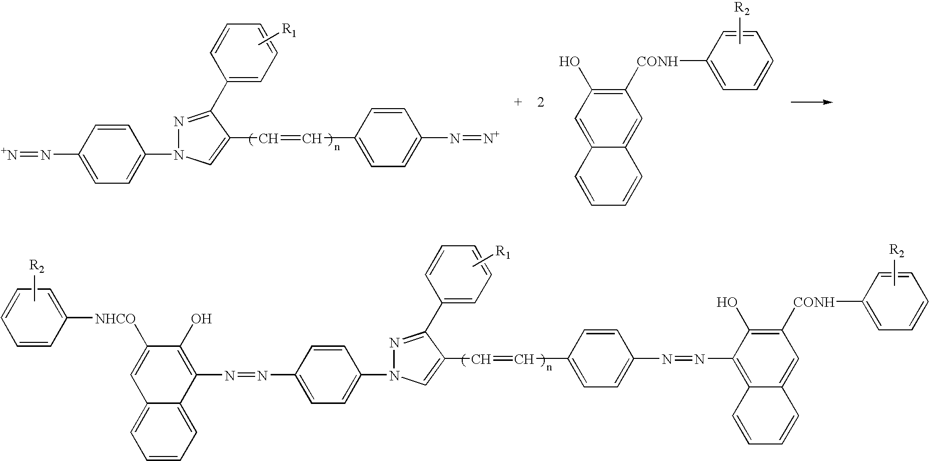

Particular examples of the bisazo-based compound represented by the Formula 1 according to various embodiments of the present general inventive concept include the following compounds:

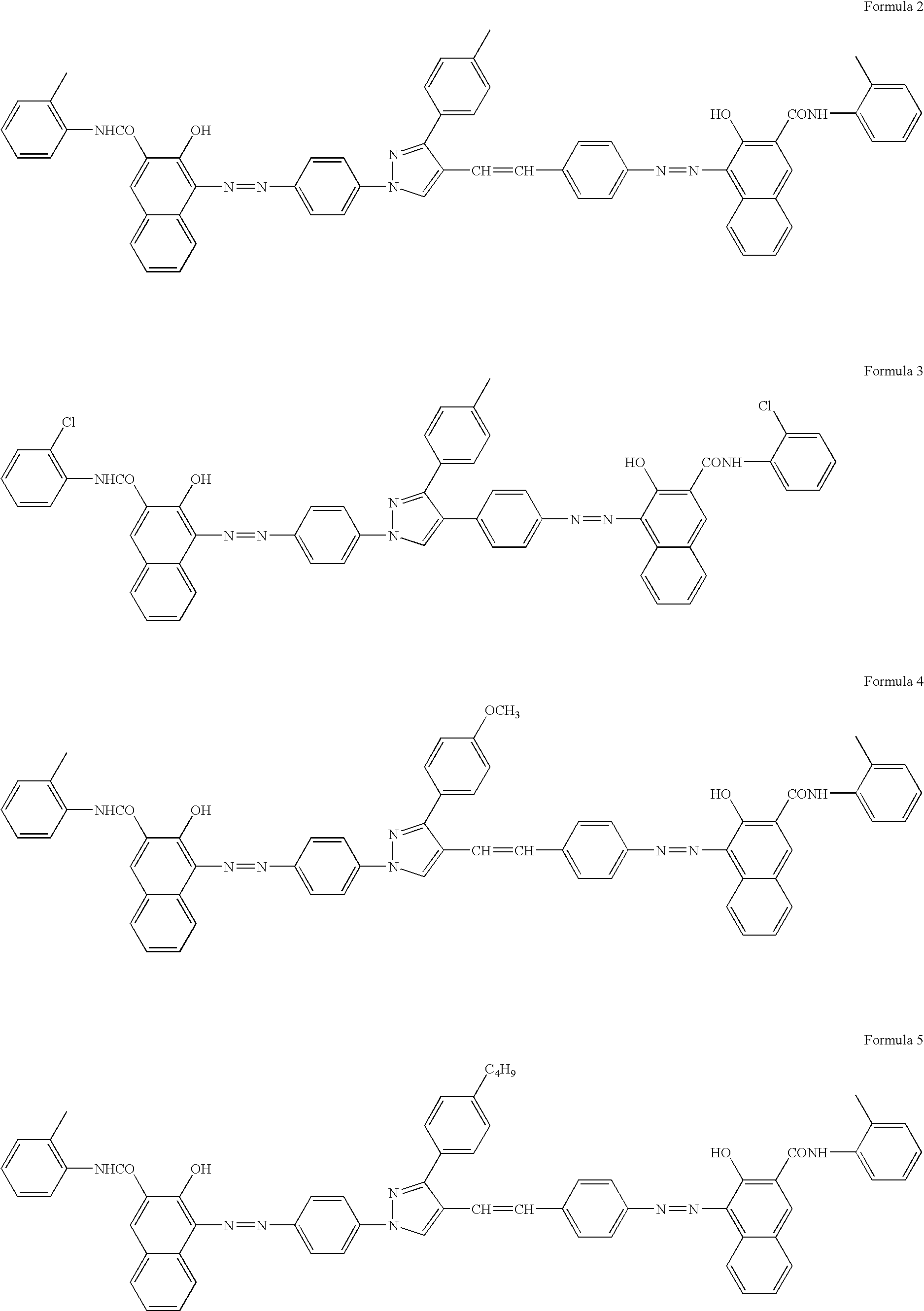

An amount of the bisazo-based charge generating material represented by the Formula 1 is less than 1 wt %, such as 0.01 wt % to 1 wt %, including 0.03 wt % to 0.5 wt %, and including 0.05 wt % to 0.2 wt % based on the weight of the hole transporting material. If the amount of the bisazo-based charge generating material is less than 0.01 wt %, the amount of charges generated in the charge transporting layer is not sufficient and accordingly, the ability to suppress the ghost phenomenon is insufficiently low. Even if the amount exceeds 1 wt %, the ability to suppress the ghost phenomenon is not further increased.

The hole transporting material and the bisazo-based charge generating material of the Formula 1 are dissolved or dispersed with a binder resin in a solvent to manufacture coating composition to form a charge transporting layer, and then the composition is coated on the charge generating layer and dried to form the charge transporting layer. Examples of the binder resin used for the formation of the charge transport layer of the electrophotographic photoreceptor according to the present general inventive concept include, but are not limited to, an insulation resin which can form a film, such as polyvinyl butyral, polyarylates (condensed polymer of bisphenol A and phthalic acid, and so on), polycarbonate, a polyester resin, a phenoxy resin, polyvinyl acetate, acrylic resin, a polyacrylamide resin, a polyamide, polyvinyl pyridine, a cellulose-based resin, a urethane resin, an epoxy resin, a silicone resin, polystyrene, a polyketone, polyvinyl chloride, vinyl chloride-vinyliacetate copolymer, polyvinyl acetal, polyacrylonitrile, a phenolic resin, a melamine resin, casein, polyvinyl alcohol, and polyvinyl pyrrolidone; and an organic photoconductive polymer, such as poly N-vinyl carbazole, polyvinyl anthracene, polyvinyl pyrene, and so on. However, in the present embodiment, a polycarbonate resin is a binder resin to be used to form a charge transporting layer. In particular, in the present embodiment, polycarbonate-Z derived from cyclohexylidene bisphenol is used, rather than polycarbonate-A derived from bisphenol A or polycarbonate-C derived from methylbisphenol-A, because polycarbonate-Z has a high abrasion resistance. The amount of the binder resin used may be, for example, a ratio of 5 to 200 parts by weight, including 10 to 150 parts by weight of the hole transporting material and the bisazo-based charge generating material of Formula 1 combined together to 100 parts by weight of the binder resin.

The charge transporting layer may further comprise a phosphate-based compound, a phosphine oxide-based compound, a silicone oil, or the like in order to enhance the abrasion resistance and provide a surface of the charge transporting layer with slip.

The solvent used to prepare the coating composition to form the charge transporting layer of the electrophotographic photoreceptor according to the present embodiment may be varied according to a type of the binder resin, and may be selected in such a way that the charge generating layer formed underneath is not affected. Specifically, the solvent may be, for example, aromatic hydrocarbons such as benzene, xylene, ligroin, monochlorobenzene, and dichlorobenzene; ketones such as acetone, methyl ethyl ketone, and cyclohexanone; alcohols such as methanol, ethanol, and isopropanol; esters such as ethyl acetate and methyl cellosolve; halogenated aliphatic hydrocarbons such as carbon tetrachloride, chloroform, dichloromethane, dichloroethane, and trichloroethylene; ethers such as tetrahydrofuran(THF), dioxane, dioxolan, ethylene glycol, and monomethyl ether; amides such as N,N-dimethyl formamide, N,N-dimethyl acetamide; and sulfoxides such as dimethyl sulfoxide. These solvents may be used alone or in combination of two or more.

Next, a method of preparing the coating composition to form the charge transporting layer will be described.

First, 100 parts by weight of binder resin, 5-200 parts by weight of the hole transporting material and the bisazo-based charge generating material of Formula 1 combined together, and an appropriate amount of selective component are mixed with an appropriate amount of solvent, for example, 100-1,500 parts by weight, such as 300-1,200 parts by weight of solvent, and then agitated. The prepared coating solution to form the charge transporting layer is coated on the charge generating layer using, as described above, a dip coating method, a ring coating method, a roll coating method, a spray coating method, or the like. The conductive substrate on which the charge transporting layer is coated is dried at 90 to 200° C. for 0.1 to 2 hours, thereby forming the charge transporting layer.

A thickness of the charge transporting layer may be 2 to 100 μm, such as 5 to 50 μm, including 10 to 40 μm. When the thickness of the charge transporting layer is less than 2 μm, the charge transporting layer is too thin, and thus durability is not sufficient. When the thickness of the charge transporting layer exceeds 100 μm, the physical abrasion resistance tends to increase but the printing image quality tends to be deteriorated.

The electrophotographic photoreceptor according to the present embodiment may further include additives such as an antioxidant, an optical stabilizer, a plasticizer, a leveling agent, and a dispersion stabilizing agent in at least one of the charge transporting layer and the charge generating layer in order to increase stability of the electrophotographic photoreceptor with respect to environmental conditions or harmful light. Examples of the antioxidant may include any known antioxidant, for example, hindered phenol-based compounds, sulfur-based compounds, esters of phosphonic acid, esters of hypophosphoric acid, and amine-based compounds, but are not limited thereto. Examples of the optical stabilizer may include any know optical stabilizer, for example, benzotriazole-based compounds, benzophenone-based compounds, and hindered amine-based compounds, but are not limited thereto. The electrophotographic photoreceptor according to the present embodiment may further include a surface protecting layer, if necessary.

The electrophotographic photoreceptor according to the present embodiment may be incorporated into electrophotographic imaging apparatuses such as laser printers, copying machines, facsimile machines, LED printers, and the like.

Hereinafter, an electrophotographic imaging apparatus employing an electrophotographic photoreceptor according to the present embodiment will be described.

The electrophotographic imaging apparatus according to the present general inventive concept includes an electrophotographic photoreceptor, the electrophotographic photoreceptor being a laminate-type electrophotographic photoreceptor including an electrically conductive substrate; and a photosensitive layer formed on the electrically conductive substrate, wherein the photosensitive layer includes a charge generating layer and a charge transporting layer, wherein the charge transporting layer contains a bisazo-based compound represented by the foregoing Formula 1 as a charge generating material.

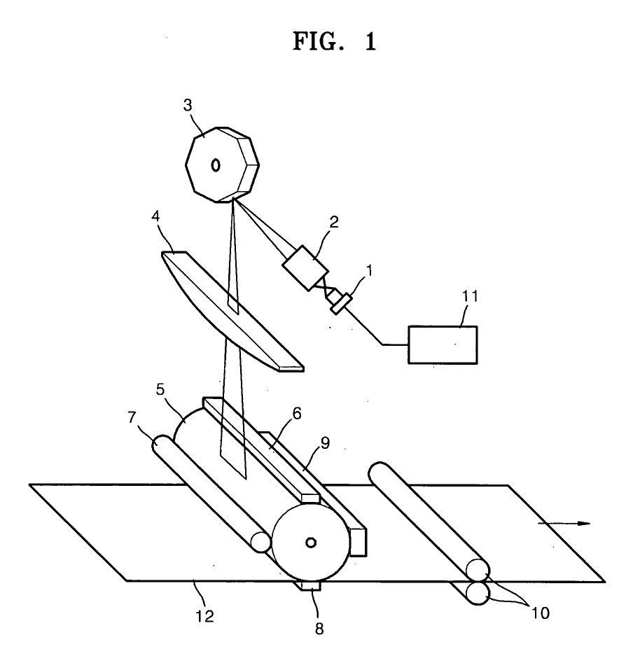

FIG. 1 is a schematic view illustrating the electrophotographic imaging apparatus according to an embodiment of the present general inventive concept.

Referring to FIG. 1, the electrophotographic imaging apparatus according to the current embodiment of the present invention includes a semiconductor laser 1. Laser light that is signal-modulated by a control circuit 11 according to image information, is collimated by an optical correction system 2 after being radiated and performs scanning while being reflected by a polygonal rotatory mirror 3. The laser light is focused on a surface of an electrophotographic photoreceptor 5 by a f-θ lens 4 and exposes the surface according to the image information. Since the electrophotographic photoreceptor may be already charged by a charging apparatus 6, an electrostatic latent image is formed by the exposure, and then becomes visible by a developing apparatus 7. The visible image is transferred to an image receptor 12, such as paper, by a transferring apparatus 8, and is fixed in a fixing apparatus 10 and provided as a print result. The electrophotographic photoreceptor can be used repeatedly by removing coloring agent that remains on the surface thereof by a cleaning apparatus 9. The electrbphotographic photoreceptor here is illustrated in a form of a drum, however, as described above, the present general inventive concept is not limited thereto, and may also be in a form of a sheet, a belt, or the like.

Hereinafter, the present embodiment will be described in further detail with reference to the following examples. These examples are, however, provided for exemplary purposes and should not be construed to limit scope of the present general inventive concept.

### EXAMPLES 1

20 parts by weight of y-TiOPc (titanyloxy phthalocyanine) represented by the following Formula 6 as a charge generating material, 10 parts by weight of polyvinyl butyral (Denka, PVB 6000-C) represented by the following Formula 7 as a binder resin, 890 parts by weight of 1,2-dimethoxyethane, and 80 parts by weight of cyclohexane were sand-milled for 2 hours and then further dispersed using ultrasonic wave to obtain a composition for a charge generating layer. The composition was coated on an anodized aluminium drum with a diameter of 30 mm by using a ring bar, and then dried at a temperature of 120° C. for 20 minutes to form a charge generating layer having a thickness of 0.3 μm.

20 parts by weight of an arylamine-based compound represented by the following formula 8 and 8.6 parts by weight of an arylamine-based compound represented by the following Formula 9, as a hole transporting material, 0.03 parts by weight represented by Formula 2, as a charge generating material, and 70 parts by weight of a polycarbonate Z resin (Mitsubishi Gas Chemical, PCZ200) represented by the following Formula 11, as a binder resin, were dissolved in 500 parts by weight of a mixed solvent of THF/toluene (weight ratio=3/1) to obtain a composition for a charge transporting layer. The composition was coated on an anodized aluminium drum having the charge generating layer thereon by using a ring bar, and then dried at a temperature of 120° C. for 30 minutes to form a charge transporting layer. A total thickness of the charge generating layer and the charge transporting layer was approximately 30 μm.

### EXAMPLES 2

An electrophotographic photoreceptor drum was prepared according to the method described in Example 1, except that a compound represented by Formula 3 was used as a charge generating material instead of the compound represented by Formula 2.

### EXAMPLES 3

An electrophotographic photoreceptor drum was prepared according to the method described in Example 1, except that 28.6 parts by weight of a compound represented by the following Formula 10 was used as a hole transporting material instead of the compound represented by Formula 8 and the compound represented by Formula 9.

### EXAMPLES 4

An electrophotographic photoreceptor drum was prepared according to the method described in Example 3, except that a compound represented by Formula 3 was used as a charge generating material instead of the compound represented by Formula 2.

### COMPARATIVE EXAMPLE 1

20 parts by weight of y-TiOPc (titanyloxy phthalocyanine) represented by the following Formula 6, as a charge generating material, 10 parts by weight of polyvinyl butyral (Denka, PVB 6000-C) represented by Formula 7, as a binder resin, 890 parts by weight of 1,2-dimethoxyethane, and 80 parts by weight of cyclohexane were sand-milled for 2 hours and then further dispersed using ultrasonic wave to obtain a composition for a charge generating layer. The composition was coated on an anodised aluminium drum with a diameter of 30 mm by using a ring bar, and then dried at a temperature of 120° C. for 20 minutes to form a charge generating layer having a thickness of 0.3 μm.

20 parts by weight of an arylamine-based compound represented by the following Formula 8 and 8.6 parts by weight of an arylamine-based compound represented by the following Formula 9, as a hole transporting material, and 70 parts by weight of a polycarbonate Z resin (Mitsubishi Gas Chemical, PCZ200) represented by the following Formula 11, as a binder resin, were dissolved in 500 parts by weight of a mixed solvent of THF/toluene (weight ratio=3/1) to obtain a composition for a charge transporting layer. The composition was coated on an anodized aluminium drum having the charge generating layer thereon by using a ring bar, and then dried at a temperature of 120° C. for 30 minutes to form a charge transporting layer. A total thickness of the charge generating layer and the charge transporting layer was approximately 30 μM.

### COMPARATIVE EXAMPLE 2

An electrophotographic photoreceptor drum was prepared according to the method described in Comparative Example 1, except that 28.6 parts by weight of a compound represented by Formula 10 was used as a hole transporting material instead of the compound represented by Formula 8 and the compound represented by Formula 9.

### COMPARATIVE EXAMPLE 3

An electrophotographic photoreceptor drum was prepared according to the method described in Example 1, except that 0.03 part by weight of y-TiOPc represented by Formula 6 was used as a charge generating material instead of the compound represented by Formula 2 in forming a composition for a charge transporting layer.

### COMPARATIVE EXAMPLE 4

An electrophotographic photoreceptor drum was prepared according to the method described in Example 3, except that 0.03 parts by weight of y-TiOPc represented by Formula 6 was used as a charge generating material instead of the compound represented by Formula 2 in forming a composition for a charge transporting layer.

Table 1 illustrates components and amounts of photoreceptors in Examples 1-4 and Comparative Examples 1-4.

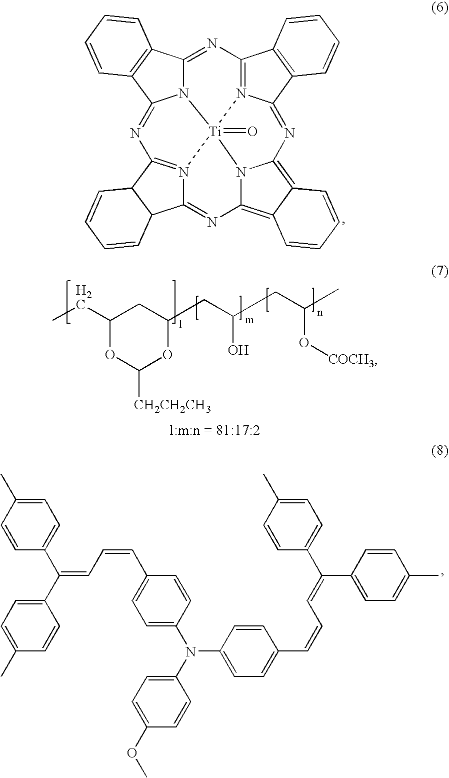

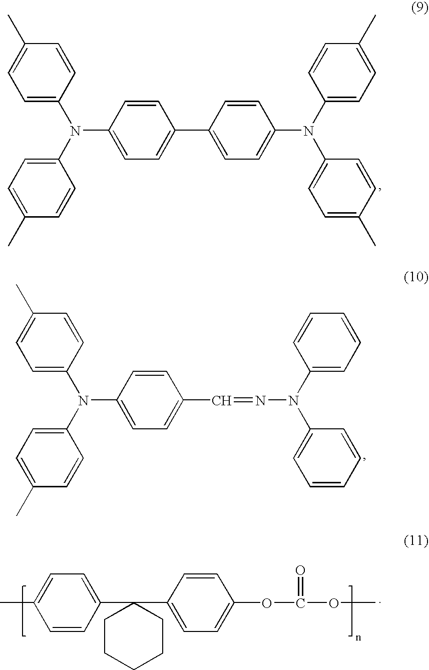

Evaluation of Electrophotographic Properties

Electrophotographic properties of the electrophotographic photoreceptors prepared in the Examples and Comparative Examples were evaluated using a drum type photoreceptor evaluating apparatus (made by Gentec Corp., Model: Cynthia 92). under environmental conditions of a temperature of 23° C. and a relative humidity of 50%.

Each of the electrophotographic photoreceptors was charged to a surface potential (V₀) of −800 V by adjusting a corona discharge voltage while rotating the electrophotographic photoreceptors at a speed of 50 rpm. Each of the electrophotographic photoreceptors was then exposed to monochromatic light having a wavelength of 780 nm, which was emitted from an exposure unit, while varying the amount of the exposure energy. Then, the relationship between exposure energies and surface potentials for each of the electrophotographic photoreceptor drums was measured. From this, E_{1/2}(μJ/cm2) which denotes the exposure energy per unit area that is required to decrease the surface potential of an electrophotographic photoreceptor drum to half of the initial surface potential thereof, in this case −400 V, were determined. E₁₀₀ (μJ/cm2) which denotes the exposure energy per unit area that is required to decrease the surface potential of an electrophotographic photoreceptor drum to −100 V were also obtained. E_{1/2} and E₁₀₀ are each a measure of sensitivity for any electrophotographic photoreceptor drum.

Ghost Evaluation

To evaluate the ghost characteristics of each of the electrophotographic photoreceptors prepared in the above Examples and Comparative Examples, the electrophotographic photoreceptors were loaded in a laser printer (Model: ML-3560, made by Samsung Electronics Inc.) and ghost characteristics thereof were evaluated under environmental conditions of a temperature of 23° C. and a relative humidity of 50%.

1,000 sheets of A4 paper were printed using an A4 test paper on which a test image pattern of the word “GHOST” having a height of 4 cm was positioned at an upper edge side of the A4 test paper. Then, whether the test image pattern at the upper edge side of the A4 test paper appeared on a lower edge side (the lower edge side corresponds to a portion that is separated from the upper edge side a distance greater than one rotation length of the photoreceptor drum) of the A4 paper printed out at the end of printing 1,000 sheets to evaluate a ghost phenomenon is determined.

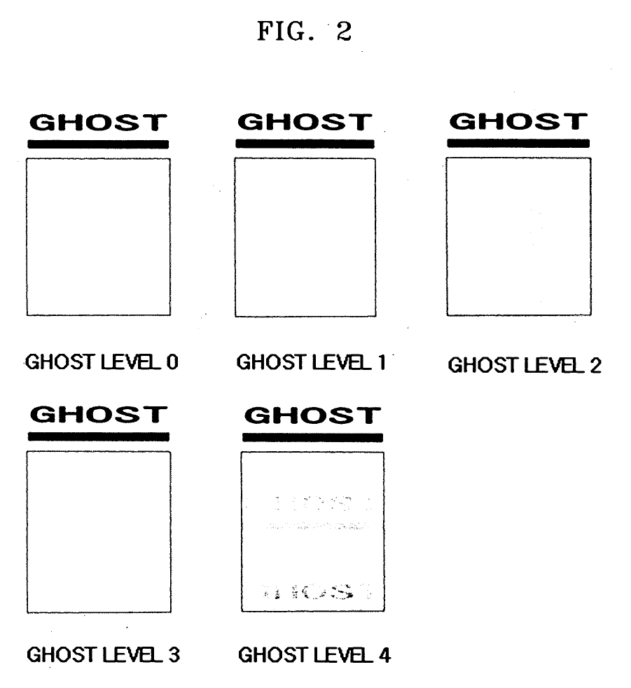

Ghost levels as evaluated were from Level 0 to Level 4. As illustrated in FIG. 2, Level 0 indicates that ghost phenomenon was not generated, Level 4 indicates that ghost phenomenon is the most severe, and thus as a number increases, the more severe the ghost phenomenon is generated. The ghost evaluation was performed to both a case where 1,000 sheets of A4 paper were printed without using an eraser lamp emitting white light having a wavelength of approximately 550-650 nm, and a case where 1,000 sheets of A4 paper were printed using the eraser lamp.

The below table 1 illustrates the results of electrical characteristics measurements and ghost evaluations of the electrophotographic photoreceptor drums.

TABLE 1

| | | | | | Ghost Level after | |
|---|---|---|---|---|---|---|
| | | | | | printing of 1000 | |
| | CGM added in | | E1/2 | E100 | sheets | |
| | CTL | CTM added in CTL | (μJ/cm2) | (μJ/cm2) | Eraser off | Eraser on |
| Example 1 | Compound (2) | Compound (8), (9) | 0.120 | 0.282 | 4 | 0 |
| Example 2 | Compound (3) | Compound (8), (9) | 0.116 | 0.280 | 3 | 0 |
| Example 3 | Compound (2) | Compound (10) | 0.125 | 0.301 | 4 | 0 |
| Example 4 | Compound (3) | Compound (10) | 0.122 | 0.299 | 4 | 0 |
| Comparative | Not added | Compound (8), (9) | 0.119 | 0.287 | 4 | 2 |
| Ex. 1 | | | | | | |
| Comparative | Not added | Compound (10) | 0.123 | 0.296 | 4 | 1 |
| Ex. 2 | | | | | | |
| Comparative | Compound (6) | Compound (8), (9) | 0.124 | 0.305 | 4 | 2 |
| Ex. 3 | y-TiOPc | | | | | |
| Comparative | Compound (6) | Compound (10) | 0.122 | 0.298 | 4 | 2 |
| Ex. 4 | y-TiOPc | | | | | |

Referring to table 1, initial sensitivities E_{1/2} and E₁₀₀ of the electrophotographic photoreceptors in Examples 1-4 and Comparative Examples 1-4 are nearly the same. However, there is large differences between the Examples and Comparative Examples in terms of an occurrence of the ghost phenomenon after printing out 1,000 sheets of A4 paper.

By comparing the ghost levels after printing 1,000 sheets of the paper without using the exposure lamp, the ghost levels of the electrophotographic photoreceptors of Comparative Examples 1-4 are level 4 and the ghost levels of Examples 1-4 are level 3 or 4, and thus, exhibit severe ghost phenomenon.

By comparing the ghost levels after printing out 1,000 sheets while using the exposure lamp, the ghost levels of the electrophotographic photoreceptors of Comparative Examples 1-4 are level 1 or 2, which is a considerable decrease in terms of ghost level. However, the ghost phenomenon does not completely disappear. This result illustrates that even when using the eraser lamp, charge traps remain in the charge transporting layer and thus the ghost phenomenon does not completely disappear. Alternatively, in the case of Examples 1-4 to which a bisazo-based charge generating material, represented by Formula 1, is added in a charge transporting layer, ghost levels therein are all level 0, which illustrates that the ghost phenomenon does not occur completely. This result illustrates that an occurrence of the ghost phenomenon is suppressed because charges generated by molecules of the bisazo-based compounds of Formulas 2 and 3 upon absorption of white light of the erasure lamp is capable of effectively removing the charge traps remaining in the charge transporting layer.

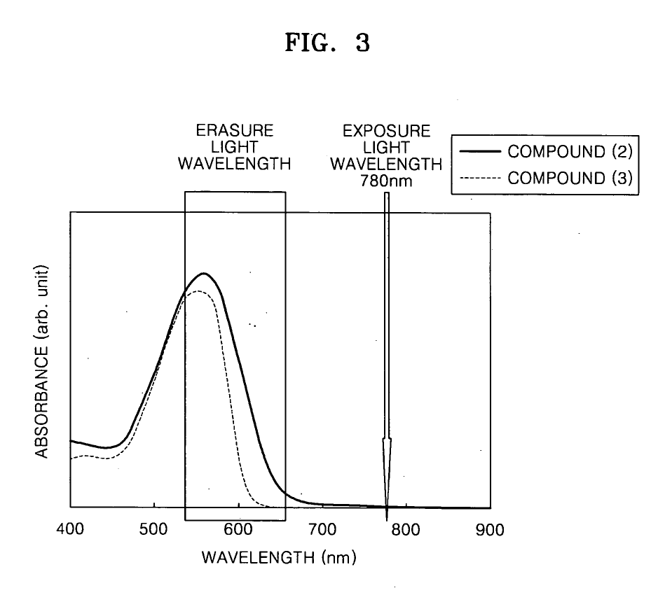

FIG. 3 illustrates an absorption spectra of compound 2 and compound 3 which are each a charge generating material added in a charge transporting layer of an electrophotographic photoreceptor, according to the present general inventive concept.

Referring to FIG. 3, compounds 2 and 3 used in Examples 1-4 absorb an erasure light, with a wavelength band of approximately 550 to 650 nm and emitted from the erasure lamp of the electrophotographic imaging apparatus, to a considerable degree but are transparent to an exposure light, with a wavelength of 780 nm, emitted from an exposure unit, i.e., a laser scanning unit (LSU). Accordingly, since compounds 2 and 3 do not absorb the exposure light, but are capable of absorbing the erasure light, with the wavelength band of approximately 550-650 nm, emitted from the erasure lamp, without deteriorating sensitivity of an electrophotographic photoreceptor, so as to remove charge traps remaining in the charge transporting layer, thereby suppressing the ghost phenomenon from occurring.

Also, a superior solubility of compounds 2 and 3 to an organic solvent is a characteristic necessary to suppress the ghost phenomenon. Since the respective compounds are easily dissolved to an organic solvent used for the composition for a charge transporting layer, the respective compounds can be uniformly dispersed in a molecular level in the charge transporting layer. Accordingly, the respective compounds can effectively remove the charge traps remaining in the charge transporting layer. If compounds 2 and 3 have an inferior solubility to the organic solvent or have no solubility, the respective compounds cannot be uniformly dispersed in the charge transporting layer and covering an entire area of the charge transporting layer with the compounds 2 and 3 is difficult. Accordingly, the ghost suppression effect will be decreased.

Also, in the case of Comparative Examples 3 and 4 containing titanyloxy phthalocyanine (y-TiOPc), in the charge transporting layer, having a very bad solubility to an organic solvent and absorbing almost no light emitted from the eraser lamp, severe ghost phenomenon is exhibited which is nearly the same as Comparative Examples 1 and 2 in which a charge generating material is not added in the charge transporting layer.

As described above, an electrophotographic photoreceptor according to various embodiments of the present general inventive concept has a superior sensitivity and can effectively suppress a ghost phenomenon that may be generated by charge traps remaining in a charge transporting layer in a repetitive use thereof. Accordingly, the photoreceptor according to various embodiments of the present general inventive concept can stably provide a high quality image even if repetitively used.

While the present general inventive concept has been particularly illustrated and described with reference to exemplary embodiments thereof, it will be understood by one of ordinary skill in the art that various changes in form and details may be made therein without departing from the spirit and scope of the present general inventive concept as defined by the following claims.

What is claimed is:

1. A laminate type electrophotographic photoreceptor, comprising:
an electrically conductive substrate; and
a photosensitive layer formed on the electrically conductive substrate, the photosensitive layer comprises:
a charge generating layer and a charge transporting layer, the charge transporting layer contains a bisazo-based compound represented by the following Formula 1 as a charge generating material: 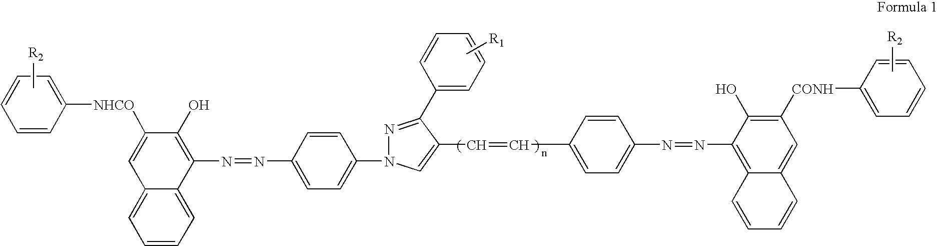
wherein R1 and R2 each independently represent a hydrogen atom, a halogen atom, a C1-C20 substituted or unsubstituted alkyl group, or a C1-C20 substituted or unsubstituted alkoxy group; and n is an integer in a range from 0 to 6.

2. The laminate type electrophotographic photoreceptor of claim 1, wherein R1 is a C1-C7 alkyl group or a C1-C7 alkoxy group, and R2 is a chlorine atom, C1-C7 alkyl group or a C1-C7 alkoxy group.

3. The laminate type electrophotographic photoreceptor of claim 1, wherein the charge generating layer contains a phthalocyanine-based pigment as the charge generating material, and the charge transporting layer further contains an arylamine-based compound as a hole transporting material.

4. The laminate type electrophotographic photoreceptor of claim 1, wherein the bisazo-based compound contained in the charge transporting layer absorbs light having wavelengths in a range of 550-650 nm, emitted from an eraser lamp of an electrophotographic imaging apparatus to generate charges so that charge traps remaining in the charge transporting layer are removed.

5. The laminate type electrophotographic photoreceptor of claim 1, wherein the bisazo-based compound contained in the charge transporting layer is transparent to light having a wavelength of 780 nm and emitted from an exposure unit of an electrophotographic imaging apparatus.

6. An electrophotographic imaging apparatus, comprising:
an electrophotographic photoreceptor, the electrophotographic photoreceptor being a laminate-type electrophotographic photoreceptor comprising an electrically conductive substrate, and a photosensitive layer formed on the electrically conductive substrate, the photosensitive layer comprises:
a charge generating layer and a charge transporting layer, the charge transporting layer contains a bisazo-based compound represented by the foregoing Formula 1 as a charge generating material: 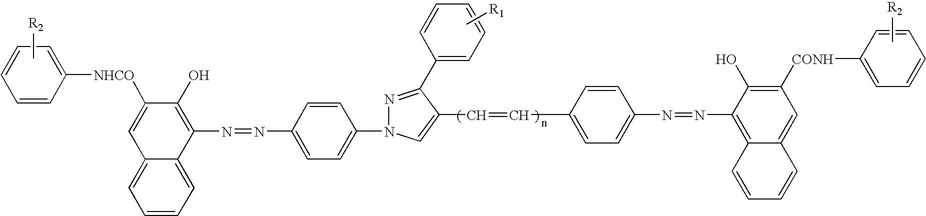
wherein R1 and R2 each independently represent a hydrogen atom, a halogen atom, a C1-C20 substituted or unsubstituted alkyl group, or a C1-C20 substituted or unsubstituted alkoxy group; and
n is an integer in a range from 0 to 6.

7. The electrophotographic imaging apparatus of claim 6, wherein R1 is a C1-C7 alkyl group or a C1-C7 alkoxy group, and R2 is a chlorine atom, a C1-C7 alkyl group or a C1-C7 alkoxy group.

8. The electrophotographic imaging apparatus of claim 6, wherein the charge generating layer contains a phthalocyanine-based pigment as the charge generating material, and the charge transporting layer further contains an arylamine-based compound as a hole transporting material.

9. The electrophotographic imaging apparatus of claim 6, wherein the bisazo-based compound contained in the charge transporting layer absorbs light having wavelengths in a range of 550-650 nm emitted from an eraser lamp of the electrophotographic imaging apparatus to generate charges so that charge traps remaining in the charge transporting layer are removed.

10. The electrophotographic imaging apparatus of claim 6, wherein the bisazo-based compound contained in the charge transporting layer is transparent to light having a wavelength of 780 nm and emitted from an exposure unit of the electrophotographic imaging apparatus.

11. A laminate type electrophotographic photoreceptor usable with an electrophotographic imaging apparatus, the laminate type electrophotographic photoreceptor comprising:
a charge generating layer; and
a charge transporting layer, the charge transporting layer having a bisazo-based compound represented by the following formula as a charge generating material: 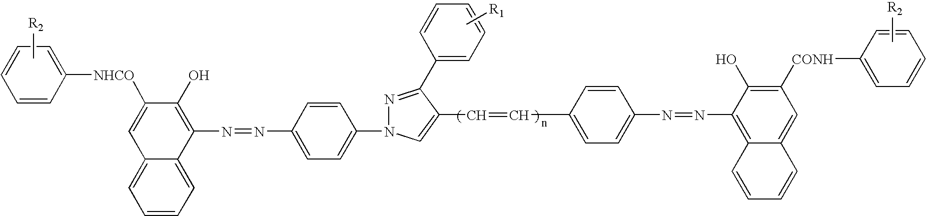
wherein R1 and R2 each independently represent a hydrogen atom, a halogen atom, a C1-C20 substituted or unsubstituted alkyl group, or a C1-C20 substituted or unsubstituted alkoxy group; and n is an integer in a range from 0 to 6.
